(19) United States
(12) Patent Application Publication
(10) Pub. No.: US 2017/0122411 A1
(43) Pub. Date: May 4, 2017

(54) DRIVE DEVICE FOR MOTOR VEHICLE

(71) Applicant: Kazuyoshi HIRAIWA, Yokohama (JP)

(72) Inventor: Kazuyoshi HIRAIWA, Yokohama (JP)

(21) Appl. No.: 14/930,127

(22) Filed: Nov. 2, 2015

(51) Int. Cl. F16H 3/091; F16H 3/00

(52) U.S. Cl. CPC F16H 3/091; F16H 3/006; F16H 2200/006; F16H 2200/0065; F16H 2200/0069

(57) ABSTRACT

A drive device has a first clutch and a second clutch. A first shaft is driven by the first clutch, being selectively connectable with a first drive gear, a second drive gear and a third drive gear. A second drive shaft is driven by the second clutch, being selectively connected with a fourth drive gear and a fifth drive gear. A driven shaft supports a first driven gear engaged with the first and fourth drive gears, a second driven gear engaged with the second and fifth drive gears, and a third driven gear engaged with a third drive gear, being connectable the driven gears. The first driven gear is connectable with the second driven gear.

### BACKGROUND OF THE INVENTION

1. Field of the Invention

The present invention relates to a drive device, adapted for a motor vehicle, that belongs to, what is called, a dual clutch transmission (DCT) equipped with two clutches between an internal combustion engine and gears of the transmission.

2. Description of the Related Art

Conventional drive devices for motor vehicles are disclosed in Japanese Patent Applications Laying-Open publication No. 2014-101953 and No. 2014-020384. These conventional drive devices include a plurality of gears arranged parallel on shafts, two clutches that change a flow of an input from an engine to intended gears of the gears to establish a forward tenth speed (the former conventional one) or a forward ninth speed (the latter conventional one).

Specifically, the conventional drive devices have a plurality of gear pairs that are capable of providing odd-number speeds and another plurality of gear pairs that is capable of providing even-number speeds. The gear pairs for odd-number speeds and the gear pairs for the even-number speeds are respectively arranged between one of the input shafts (power shafts) and an output shaft and between the other of the input shafts (or the power shafts) and the output shaft. In addition, the both devices further have gear pairs of an auxiliary transmission capable of establishing a high speed and a low speed. Then they can basically establish eight forward speeds [(High speeds 2+LOW speeds 2)×auxiliary transmission speeds 2=8 speeds], and finally they are set to provide ten forwards speed and nine forward speeds, respectively.

The above known conventional drive devices, however, encounter a problem in that the conventional devices cannot provide an eight forward speed transmission, which is shiftable only by two clutches, without an auxiliary transmission or the like in order to be placed in a narrow engine room of a motor vehicle, in other words, in a limited axial direction. This increases the number of the transmission.

That is, it is necessary for the conventional drive devices to set another speed or another speeds between the LOW speeds and the HIGH speeds. In the former conventional device is designed to have the low forward speeds (forward first—fourth speed) and the high forward speeds (forward seventh—tenth speed), adding a forward fifth speed and a forward sixth speed by using the auxiliary-transmission mechanism and an additional clutch. On the other hand, the latter conventional device is designed to have the low forward speeds (forward first speed—fourth speed) and the high forward speeds (forward sixth—ninth speed), adding a forward fifth speed by using another gear pair and an additional clutch, where the latter conventional device shifts between a high speed and a low speed during the fifth speed being maintained. As understood from the above, the conventional drive devices need the additional clutch and a certain forward speed/certain forward speeds to provide an eight or more-than eight forward speed transmission. As described above, the conventional drive devices needs the additional clutch in addition to the two clutches.

It is, therefore, an object of the present invention to provide a drive device for a motor vehicle which overcomes the foregoing drawbacks and can provide forward eight speeds only by using two clutches, thereby providing a forward eight speed transmission and a forward more-than eight speed transmission that are speed-shifted only by two clutches, not being necessary for an additional clutch like the conventional drive devices.

### SUMMARY OF THE INVENTION

According to a first aspect of the present invention there is provided a drive device for a motor vehicle that includes a first clutch that is capable of receiving power from a crank shaft of an engine, a second clutch that is capable of receiving the power from the crank shaft, a driven shaft, a first drive gear, a second drive gear, a third drive gear, a fourth drive gear, a fifth drive gear, a first driven gear, a second driven gear, a third driven gear, a first selectively connecting mechanism, a second selectively connecting mechanism, a third selectively connecting mechanism, a first drive shaft, a second drive shaft that is arranged parallel to the first drive shaft, and a driven shaft. The first drive shaft is capable of receiving the power through the first clutch, rotatably supporting the first drive gear and the second drive gear. The first drive shaft is capable of being connected selectively with one of the first drive gear and the second drive gear through the first selectively connecting mechanism. The second drive shaft is capable of receiving the power that rotates at a speed lower than that of the first drive shaft, rotatably supporting the fourth drive gear and the fifth drive gear. The second drive shaft is capable of being connected selectively with one of the fourth drive gear and the fifth drive gear through the second selectively connecting mechanism. The third drive gear is formed integrally with one of the second drive gear and the fifth drive gear. The first driven gear is arranged parallel to the first drive shaft and the second drive shaft, and the first driven gear is engaged with the first drive gear and the fourth drive gear. The second driven gear is engaged with the second drive gear and the fifth drive gear. The third driven gear is engaged with the first drive gear. The driven shaft rotatably supports the first driven gear, the second driven gear and the third driven gear, being connectable selectively with the first driven gear, the second driven gear and the third driven gear through the third selectively connecting means. The first driven gear is capable of being selectively connected with the second driven gear.

Preferably, the drive device further includes a power intermediate gear, and the second clutch is capable of being driven by the crank shaft through the power intermediate gear.

Preferably, the drive device further includes a plurality of gears and a fourth selectively connecting mechanism. The gears are arranged between the first drive shaft and the first drive gear. The fourth selectively connecting mechanism is capable of connecting the first drive shaft with the first drive gear. The first drive shaft drives the first drive gear at a reduction speed through the gears and the fourth selectively connecting mechanism to establish a first speed.

Preferably, the drive device further includes an input intermediate gear. The crank shaft is connected with the second clutch, and the second clutch drives the second drive shaft at a reduction speed through the input intermediate gear.

Preferably, the drive device further includes a plurality of gears and a fifth selectively connecting mechanism. The gears are arranged between the first drive shaft and the input intermediate gear. The fifth selectively connecting mechanism is capable of connecting the first drive shaft with the input intermediate gear. The first drive shaft drives the input intermediate gear at a reduction speed through the gears and the fifth selectively connecting mechanism.

Preferably, the drive device further includes a single sleeve that is capable of connecting the first driven gear with the driven shaft and further connecting the first driven gear with the second driven gear.

### BRIEF DESCRIPTION OF THE DRAWINGS

The objects, features and advantages of the present invention will become apparent as the description proceeds when taken in conjunction with the accompanying drawings, in which:

FIG. 1 is a schematic diagram showing a power train of a drive device for a motor vehicle of a first embodiment according to the present invention;

FIG. 2 is a side view showing the drive device of the first embodiment;

FIG. 3 is an operation table showing operations of the drive device of the first embodiment;

FIG. 4 is a schematic diagram showing a power train of a drive device for a motor vehicle of a second embodiment according to the present invention;

FIG. 5 is a side view showing the drive device of the second embodiment;

FIG. 6 is an operation table showing operations of the drive device of the second embodiment;

FIG. 7 is a schematic diagram showing a power train of a drive device for a motor vehicle of a third embodiment according to the present invention;

FIG. 8 is a side view showing the drive device of the third embodiment;

FIG. 9 is an operation table showing operations of the drive device of the third embodiment; and

FIG. 10 is a partially cross-sectional view showing a third sleeve and its periphery of the third embodiment.

### DETAILED DESCRIPTION OF THE PREFERRED EMBODIMENTS

Throughout the following detailed description, similar reference characters and numbers refer to similar elements in all figures of the drawings, and their descriptions are omitted for eliminating duplication.

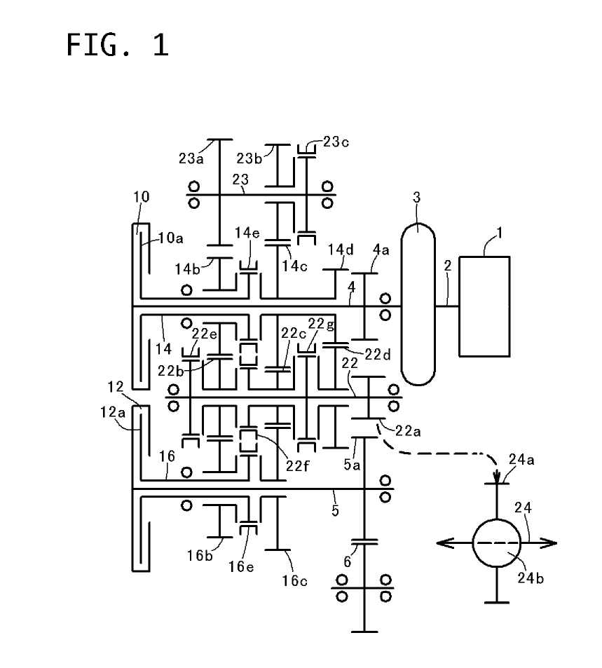

Referring to FIGS. 1-3 of the drawings, there is shown a first preferred embodiment of a drive device for a motor vehicle according to the present invention.

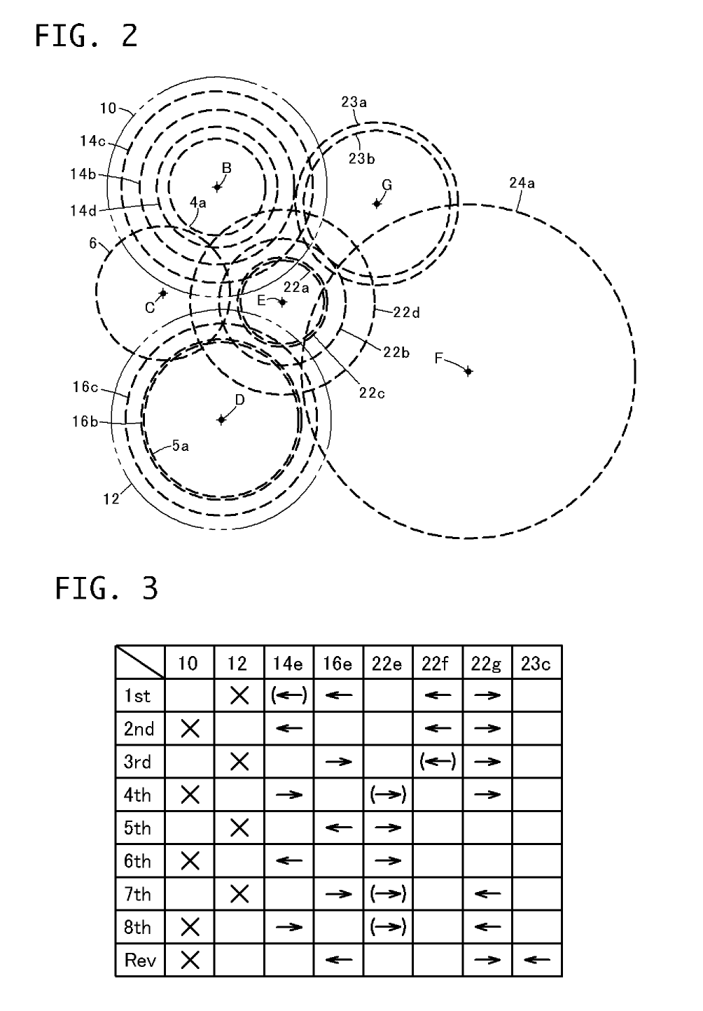

As shown in FIG. 1, an internal combustion engine 1 has a crank shaft 2, which is capable of driving a first power shaft 4 and a second power shaft 5 through a torque converter 3. Power of the engine 1 is capable of being inputted to the first power shaft 4, the second power shaft 5, and a power intermediate gear 6 that is arranged between the first power shaft 4 and the second power shaft 5. The power intermediate gear 6 is always engaged with a first power gear 4a formed integrally with the first power shaft 4 and a second power gear 5a formed integrally with the second power shaft 5 as shown in FIG. 2, although the gear 6 and the first power gear 4a are illustrated to be apart from each other in FIG. 3 for convenience.

The first power shaft 4 is capable of driving a first drive shaft 14 through a first clutch 10, while the second power shaft 5 is capable of driving a second drive shaft 16 through a second clutch 12. The first clutch 10 and the second clutch 12 are shiftable between a released state (a disengagement state) and an applied state (an engagement state). When they are applied, the power from an engine 1 is capable of being transmitted to the first drive shaft 14 and the second drive shaft 16 through a first clutch plate 10a of the first clutch 10 and a second clutch plate 12a of the second clutch 12, respectively.

The drive device has a driven shaft 22, an accessory shaft 23, and an output shaft 24 in addition to the first drive shaft 14 and the second drive shaft 16. These shafts will be later described in detail with reference to FIG. 2. The first drive shaft 14 is arranged in coaxial with the crank shaft 2, while the other shafts 16, 22, 23 and 24 are arranged parallel to the first drive shaft 14.

The power is capable of being transmitted to the output shaft 24 through a power driven gear 24a that engages with an output drive gear 22a formed integrally with the driven shaft 22, and then it drives not-shown left and right drive wheels through differential gears 24b and others. Incidentally, in FIG. 1, the power driven gear 24a and the difference gears 24b are illustrated at positions apart from other parts, being scaled down, for convenience.

FIG. 2 is a view of the drive device, seen from a left side in FIG. 1, showing centers B-G of the first and second clutches 10, 12, the shafts 14, 16, 22, 23, 24, and gears 14a-14d, 16b, 16c, 22a-22d, 23a, 23b, 24a, 24b, which will be later described.

The center B corresponds to centers of the crank shaft 2, the first clutch 10, the first drive shaft 14, and the gears 14a, 14b, 14c, 14d that are supported on the first drive shaft 14.

The center C corresponds to a center of the power intermediate gear 6.

The center D corresponds to centers of the second clutch 12, the second drive shaft 16, and the gears 16b, 16c that are supported on the second drive shaft 16.

The center E corresponds to centers of the driven shaft 22, the output drive gear 22a, and the gears 22b, 22c, 22d that are rotatably supported on the driven shaft 22.

The center F corresponds to centers the output shaft 24, the output driven gear 24a, and the difference gears 24b.

The center G corresponds to centers of the accessory shaft 23, a first accessary-shaft gear 23a formed integrally with the accessary shaft 23, and a second accessary-shaft 23b rotatably supported on the accessary shaft 23. Incidentally, a distance between the center E and the center B is set equal to a distance between the center E and the center D.

In addition, in FIG. 2, outer diameters of the gears are illustrated by bold dashed lines, while outer diameters of the clutches 10 and 12 are illustrated by thin alternate long and two short dashes lines.

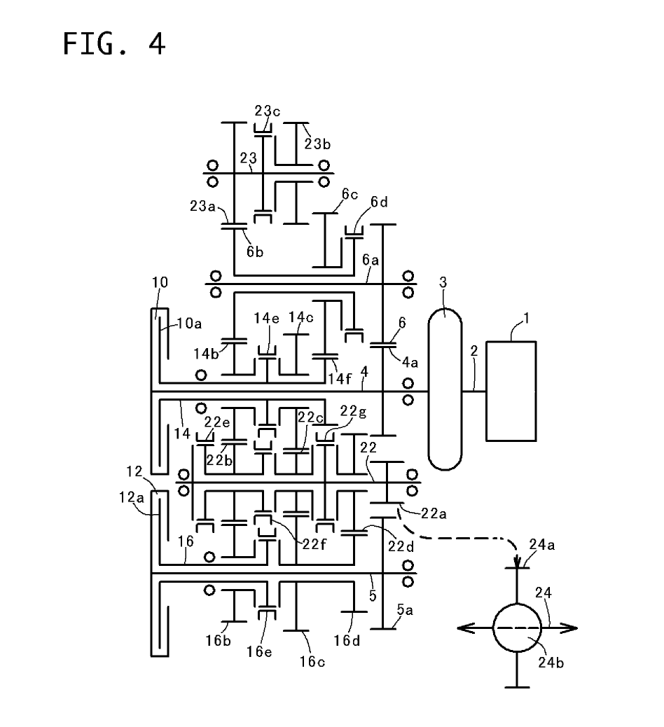

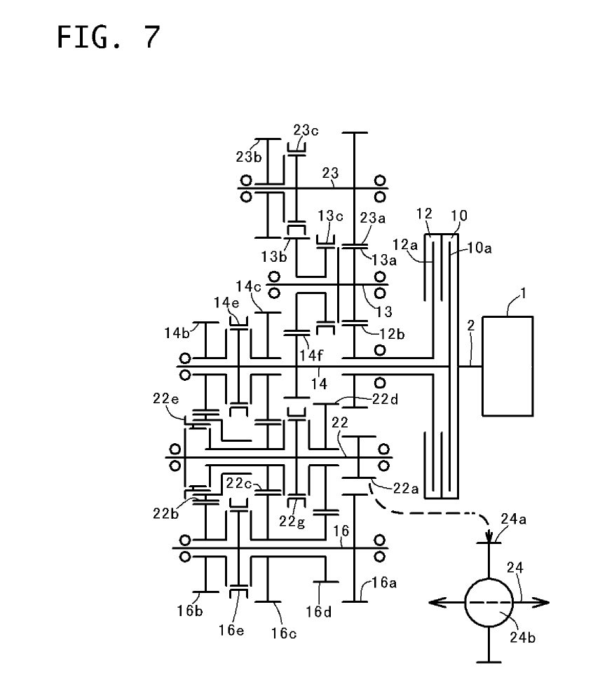

Then, the gears will be explained in detail with their respective names. Incidentally, in FIG. 1, bearings arranged on the shafts are illustrated by symbols O, and outer races of them are fixed on a not-shown transmission case (similarly in FIGS. 4 and 7 of other embodiments).

The first drive gear 14b, the second drive gear 14c, and the third drive gear 14d formed integrally with the second drive gear 14c are rotatably supported on the first drive shaft 14, which the first power shaft 4 penetrates, being arranged in order from the left side toward the right side in FIG. 1.

A first sleeve 14e that rotates together with the first drive shaft 14 is capable of moving along the shaft 14 to be connected selectively with one of the first drive gear 14b and the second drive gear 14c formed integrally with the third drive gear 14d. FIG. 1 shows a neutral state where the first sleeve 14e is not connected with any one of the gears 14b-14d. When the first sleeve 14e is moved toward the left side in FIG. 1 to be engaged with the first drive gear 14b, the power is transmitted from the first drive shaft 14 to the first drive gear 14b. On the other hand, when the first sleeve 14e is moved toward the right side in FIG. 1 to be engaged with the second drive gear 14c (also with the third drive gear 14d), the power is transmitted from the first drive shaft 14 to the second drive gear 14c and the third drive gear 14d.

The forth drive gear 16b and the fifth drive gear 16c are rotatably supported on the second drive shaft 16, which the second power shaft 5 penetrates, being arranged in order from the left side toward the right side in FIG. 1. A second sleeve 16e that rotates together with the second drive shaft 16 is capable of moving along the shaft 16 to be connected selectively with one of the fourth drive gear 16b and the fifth drive gear 16c. The operation of the second sleeve 16e is similar to that of the first sleeve 14e, and accordingly its explanation is omitted.

The first driven gear 22b, the second driven gear 22c and the third driven gear 22d are rotatably supported on the driven shaft 22, being arranged in order from the left side toward the right side in FIG. 1.

A third sleeve 22e that rotates together with the driven shaft 22 is capable of moving along the shaft 22 to be connected with the first driven gear 22b, a fourth sleeve 22f that rotates together with the second driven gear 22c is capable of moving along the shaft 22 to be connected with the first driven gear 22b, and a fifth sleeve 22g that rotates together with the driven shaft 22 is capable of moving along the shaft 22 to be connected selectively with one of the second driven gear 22c and the third driven gear 22d.

Incidentally, the first sleeve 14e corresponds to a first selectively connecting mechanism of the present invention, the second sleeve 16e corresponds to a second selectively connecting mechanism of the present invention, and the third sleeve 22e, the fourth sleeve 22f and the fifth sleeve 22g correspond to a third selectively connecting mechanism of the present invention.

The first driven gear 22b engages with the first drive gear 14b and the fourth drive gear 16b, and respective gear ratios thereof (the number of teeth of a driven gear/the number of teeth of a drive gear) are the same, being set to be i1. The second driven gear 22c engages with the second drive gear 14c and the fifth drive gear 16e, and respective gear ratios thereof are the same, being set to be i2. Incidentally, gear dimensions of the first drive gear 14b and the fourth drive gear 16b are the same, and those of the second drive gear 14c and the fifth drive gear 16c are also the same, because the center distance between the first drive shaft 14 and the driven shaft 22 is set to be equal to that between the second drive shaft 16 and the driven shaft 22. The third driven gear 22d engages with the third drive gear 14d, and its gear ratio is set to be i3.

Herein, a relationship between the second driven gear 22c and the driven shaft 22 will be described.

As described above, the second driven gear 22c engages with the second drive gear 14c, which is formed integrally with the third drive gear 14d that engages with the third driven gear 22d. The fifth sleeve 22g engages with the second driven gear 22c when it is moved toward the left side in FIG. 1, while it engages with the third driven gear 22d when it is moved toward the right side in FIG. 1.

That is, when the fifth sleeve 22g is moved toward the left side, the driven shaft 22 is directly connected with the second driven gear 22c, while when it is moved toward the right side, the driven shaft 22 is connected with the second driven gear 22c through the second drive gear 14c, the third drive gear 14d and the third driven gear 22d.

Accordingly, a reduction ratio becomes i3/i2 between the second driven gear 22c and the driven shaft 22 (a rotational speed of the second driven gear 22c/a rotational speed of the driven shaft 22) when the fifth sleeve 22g is moved toward the right side. In other words, a “LOW” speed at the reduction ratio i3/i2 is obtained when the fifth sleeve 22g is moved toward the right side, and a “HIGH” speed in a direct connection at the gear ratio 1.0 is obtained when it is moved to the left side, and therefore the shift by the fifth sleeve 22g, the second driven gear 22c, the third driven gear 22d and so on function as an operation of an auxiliary gear box.

The first accessory-shaft gear 23a, which is formed integrally with the accessory shaft 23, engages with the first driven gear 22b. They are illustrated to be apart from each other in FIG. 3, but they actually engage with each other as shown in FIG. 2. Accordingly, the first accessory-shaft gear 23a transmits the power to the first drive gear 14b through the first driven gear 22b. The gear ratio thereof (the number of teeth of the first accessory-shaft gear 23a/the number of the teeth of the first drive gear 14b) is set −iR1. Incidentally, this value iR1 becomes a negative one because of the existence of the first driven gear 22b arranged between the first accessory-shaft gear 23a and the first drive gear 14b to function as an idle gear. The second accessory-shaft gear 23b, which is supported on the accessary shaft 23, engages with the second drive gear 14c. The gear ratio thereof (the number of teeth of the second accessary-shaft gear 23b/the number of teeth of the second drive gear 14c) is set iR2.

When the sixth sleeve 23c that rotates together with the accessary shaft 23 is moved toward the left side in FIG. 1, it connects the first accessary-shaft gear 23a with the second accessary-shaft gear 23b.

The gear ratio of the first power gear 4a and the second power gear 5a, the both of which engage with each other through the power intermediate gear 6, (the number of teeth of the second power gear 5a/the number of teeth of the first power gear 4a) is set iS.

The operation of the drive device of the first embodiment shown in FIG. 1 will be described with reference to an operation table shown in FIG. 3.

In the operation table, gear speeds such as first speed and reverse speed, which are respectively expressed as 1st and Rev, are arranged in a longitudinal direction, while the first clutch 10, the second clutch 12, and the sleeves 14e, 16e, 22e, 22f, 22g, 23c are arranged in a lateral direction. In the table, symbols “x” indicate engagement of the first clutch 10 or the second clutch 12, and symbols of arrows indicate moving directions of the sleeves 14e, 16e, 22e, 22f, 22g and 23c, respectively. Blanks and non-existence of the arrows indicate a released state and a neutral state, respectively. Quote-unquote arrows indicate that they do not transmit the power although they might be engaged.

The drive device of the first embodiment is equipped with an oil pump, a battery, various sensors, a controller, actuators and others which are necessary for activation of the drive device of the first embodiment, although they are not illustrated in FIG. 1.

The sleeves 14e, 16e, 22e, 22f, 22g and 23c have a synchronizer or synchronizers as may be necessary.

Incidentally, the same rotational direction as that of the crank shaft 2 of the engine 1 is defined as a “positive rotational direction”, while a rotational direction opposite to that of the crank shaft 2 is defined as a “negative rotational direction”.

The gear ratios are set as follows in the first embodiment, for example.

i1: 0.809

i2: 0.444

i3: 1.476

iR1: −1.057

iR2: 0.753

iS: 1.350

Incidentally, an explanation on the operation of the torque converter 3 is omitted because it is well known. Although speed ratio of the torque converter 3 varies, an input rotational speed of the first power shaft 4 is assumed as 1.0, for convenience, in a speed-ratio calculation described below.

In order to establish a first speed, the second sleeve 16e is moved toward the left side in FIG. 1 to connect the second drive shaft 16 with the fourth drive gear 16b, the fourth sleeve 22f is moved toward the left side to connect the first driven gear 22b with the second driven gear 22c, the fifth sleeve 22g is moved toward the right side to connect the driven shaft 22 with the third driven gear 22d, and then the second clutch 12 is engaged, the first clutch 10 being disengaged.

Incidentally, the first sleeve 14b might be moved toward the left side to connect with the first drive gear 14b in preparation to shift the device to a subsequent second speed.

Accordingly, at the first speed, the fourth drive gear 16b drives the first driven gear 22b through the second clutch 12, the second power shaft 6 and the second drive shaft 16. In addition, the second driven gear 22c, which is connected with the first driven gear 22b, drives the driven shaft 22 through the second drive gear 14c, the third drive gear 14d and the third driven gear 22d. The latter of these drive passages provides a “LOW” speed, which is the reduction ratio i3/i2.

Therefore, the speed ratio at the first speed (the rotational speed of the first power shaft 4/the rotational speed of the driven shaft 22) is iS·i1·i3/i2, so that it becomes 3.628 under the above-set gear-ratio condition.

In order to establish a second speed, the positions of the sleeves 14e, 16e, 22f and 22g are maintained at positions similar to those at the first speed, and then the second clutch 12 is released and the first clutch 10 is engaged. Accordingly, the first drive gear 14b, which is connected with the first drive shaft 14, drives the first driven gear 22b, and since then it drives the driven shaft 22 through the same drive passage as that at the first speed.

The speed ratio at the second speed is i1·i3/i2, so that it becomes 2.688 under the above-set gear-ratio condition.

Incidentally, the second sleeve 16e is positioned at the neutral position during the drive device being driven at the second speed in preparation to shift the device to a subsequent third speed.

In order to establish the third speed, the second sleeve 16e is moved toward the right side to connect the second drive shaft 16 with the fifth drive gear 16c during the operation at the second speed, and the first clutch 10 is released and the second clutch 12 is engaged. Accordingly, the fifth drive gear 16c drives the second driven gear 22c, and since then it drives the driven shaft 22 through the same drive passage as that at the first speed.

The speed ratio at the third speed is iS·i2·i3/i2=iS·i3, so that it becomes 1.991 under the above-set gear-ratio condition.

The first sleeve 14e is positioned at the neutral position in preparation to shift the device to a subsequent fourth speed.

In order to establish the fourth speed, the first sleeve 14e is moved to connect the first drive shaft 14 with the third drive gear 14d during the drive device being driven at the third speed, and the second clutch 12 is released and the first clutch 10 is engaged. Accordingly, the first drive shaft 14 drives the driven shaft 22 through the third drive gear 14d and the third driven gear 22d.

The speed ratio at the fourth speed is i3, so that it becomes 1.475 under the above-set gear-ratio condition.

The second sleeve 16e is positioned at the neutral position in preparation to shift the device to a subsequent fifth speed.

The fourth sleeve 22f is positioned at the neutral position and the third sleeve 22e is moved toward the right side before the drive device being shifted to the fifth speed to connect the driven shaft 22 with the first driven gear 122b. This operation may be performed at any one of the third speed or the fourth speed. In addition, the third sleeve 22e and the fourth sleeve 22f may be mechanically coupled to move together in the same axial direction.

The fourth sleeve 22f is positioned at the neutral position, so that the first driven gear 22b is disconnected from the second driven gear 22c. This enables the shift from the fourth speed to the fifth speed, which is not the LOW speed, by the first clutch 10 being engaged and the second clutch 12 being disengaged similarly to the operation of the clutches 10 and 12 when they are shifted at the other speeds.

In order to establish the fifth speed, the fourth sleeve 22f is positioned at the neutral position, the second sleeve 16e is moved toward the left side to connect the second drive shaft 16 with the fourth drive gear 16b during the device being driven at the fourth speed, and then the first clutch 10 is released and the second clutch 12 is engaged.

Accordingly, the fourth drive gear 16b drives the driven shaft 22 through the first driven gear 22b. The fifth speed corresponds to a “HIGH” speed because the engagement of the third drive gear 14d and the third driven gear 22d does not affect to it.

The speed ratio at the fifth speed is iS·i1, so that it becomes 1.092 under the above-set gear-ratio condition.

The first sleeve 14e is positioned at the neutral position in preparation to shift the device to a subsequent sixth speed.

In order to establish the sixth speed, the first sleeve 14e is moved toward the left side to connect the first drive shaft 14 with the first drive gear 14b during the device being driven at the fifth speed, and then the second clutch 12 is released and the first clutch 10 is engaged.

Accordingly, the first drive gear 14b drives the driven shaft 22 through the first driven gear 22b.

The speed ratio at the sixth speed is i1, so that it becomes 0.809 under the above-set gear-ratio condition.

The second sleeve 16e is positioned at the neutral position in preparation to shift the dive to a subsequent seventh speed.

In order to establish the seventh speed, the second sleeve 16e is moved toward the right side to connect the second drive shaft 16 with the fifth drive gear 16c during the device being driven at the sixth speed, and then the first clutch 10 is released and the second clutch 12 is engaged. Accordingly, the second drive shaft 16 drives the driven shaft 22 through the fifth drive gear 16c and the second driven gear 22c.

The speed ratio at the seventh speed is iS·i2, so that it becomes 0.599 under the above-set gear-ratio condition.

The first sleeve 14e is positioned at the neutral position in preparation to shift the device to a subsequent eighth speed.

In order to establish the eighth speed, the first sleeve 14e is moved toward the right side to connect the first drive shaft 14 with the second drive gear 14c during the device being driven at the seventh speed, and then the second clutch 12 is released and the first clutch 10 is engaged.

Accordingly, the first drive shaft 14 drives the driven shaft 22 through the second drive gear 14c and the second driven gear 22c.

The speed ratio at the eighth speed is i2, so that it becomes 0.444 under the above-set gear-ratio condition.

In order to establish a reverse speed, the second sleeve 16e and the first sleeve 22g is positioned in an engagement state similar to that at the first speed, and the sixth sleeve 23c is moved toward the left side to connect the first accessory-shaft gear 23a with the second accessory-shaft gear 23b, and then the second clutch 12 is engaged, the first clutch 10 being disengaged. Accordingly, the second drive shaft 16 drives the first accessory-shaft gear 23a through the fourth drive gear 16b and the first driven gear 22b. The second accessory-shaft gear 23b, which is connected with the first accessory-shaft gear 23a, drives the driven shaft in a reverse rotational direction through the second drive gear 14c, the third drive gear 14d and the third driven gear 22d.

The speed ratio at the reverse speed is −iS·iR1·i3/iR2, so that it becomes −2.795 under the above-set gear-ratio condition.

The above speed ratios are calculated based on theoretical values (gear ratios), having certain differences from those calculated when the respective numbers of gears are set specifically. The differences are, however, very small.

Gear steps between two neighboring speed ratios (a certain speed ratio/a speed ratio one-step higher than the certain one) at forward drive become to have a certain constant value, approximately 1.350 from the first speed to the eighth speed.

Incidentally, the explanation on the torque converter is omitted. It is provided to start a vehicle at the first speed and the reverse speed, so that it may be replaced by other devices, such as a fluid coupling.

The first drive device of the first embodiment can provide the following advantages.

Additional gears for establishing another speed between the LOW-speed gears and the HIGH-speed gears are needed in the conventional devices described above, but the device of the first embodiment can provide a forward eighth or more-than eighth speed, performing the shift between the LOW speed (fourth speed) and the HIGH speed (fifth speed) by the engagement of one of the first and second clutches 10, 12 and disengagement of the other thereof without an additional clutch.

The device of the first embodiment can suppress its longitudinal (axial) length, because there is no need to provide additional gears for establishing another speed between the LOW speeds and the HIGH speeds like the conventional drive devices. Specifically, the longitudinal lengths of drive devices are limited shorter in motor vehicles such as front-engine front-drive vehicles where engine are arranged in lateral directions of the vehicles. Accordingly, the highest possible speed of the conventional devices that are arranged in lateral directions of motor vehicles is generally limited to a seventh speed, while the device of the first embodiment can obtain eight speeds with almost the same longitudinal length as those of the conventional devices with seven speeds.

The conventional devices need another clutch in addition to the two forward clutches, while the device of the first embodiment can drive the vehicle in a backward direction by using the second clutch 12 functioning as a forward clutch. Therefore, it can substantially decrease one clutch compared to the conventional devices, further decreasing its weight and manufacturing cost.

Incidentally, when a first speed with larger speed ratio is added and the first to eighth speeds described above are shifted to new second to ninth speeds like a second embodiment, which will be later described, the device of the first embodiment can set the gear step between the first speed and the second speed to be larger than other gear steps although the conventional devices have no choice of setting the gear step between the first speed and the second speed to be almost the same values as those of other gear steps.

Next, a drive device of a second embodiment according to the present invention will be described.

The second embodiment differs from the first embodiment in that the first to eighth speeds in the first embodiment are shifted to new second to ninth speeds of the second embodiment and new first speed is added to provide a forward nine-speed drive device.

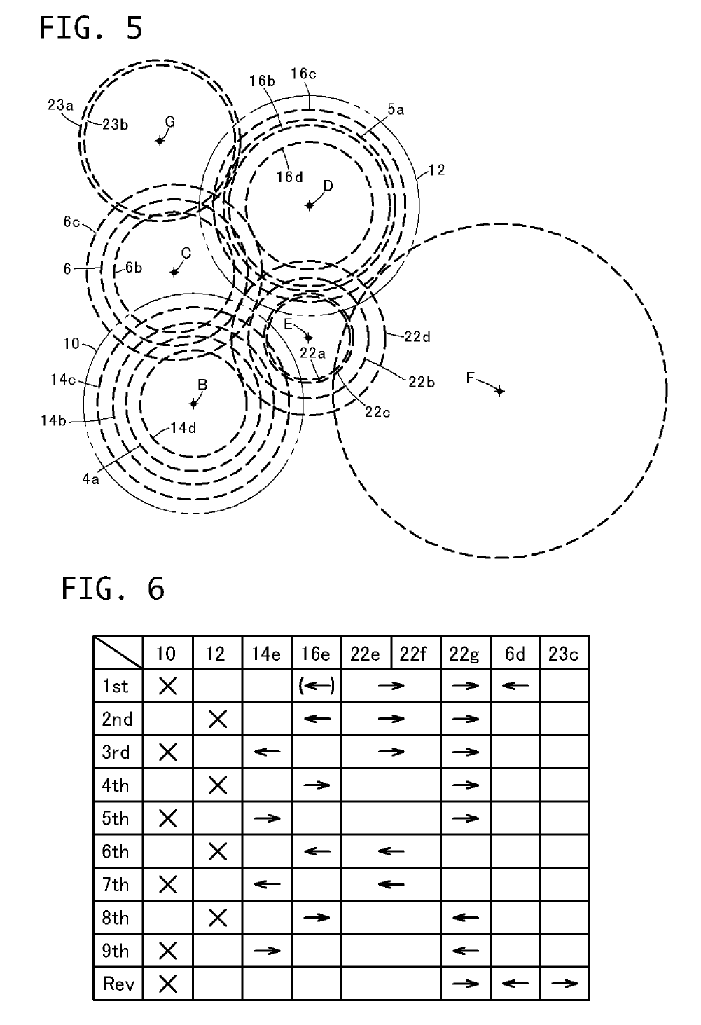

In addition, a center B and a center D of the second embodiment are arranged at sides vertically opposite to those of the first embodiment as shown in FIG. 5.

Further, it differs from the first embodiment in a construction and an engagement relationship of gears that are supported on an intermediate shaft 6a, which is formed integrally with a power intermediate gear 6, and on an accessory shaft 23.

Herein, a construction to establish the new forward first speed and a reverse speed and an explanation on reduction ratios relating to calculation of respective speed ratios will be described.

A first drive shaft 14 is provided integrally with a sixth drive gear 14f, which engages with a first intermediate gear 6c. The A first intermediate gear 6c is formed integrally with a power intermediate gear 6, being rotatably supported on an intermediate shaft 6a.

The first intermediate gear 6c is capable of connecting with a second intermediate gear 6b, which is rotatably supported on the intermediate shaft 6a, by using a seventh sleeve 6d. The second intermediate gear 6b engages with a first drive gear 14b.

Incidentally, the seventh sleeve 6d corresponds to a fourth selectively connecting mechanism of the present invention.

Herein, iL1 is set as a reduction ratio from the sixth drive gear 14f to the first drive gear 14b (the number of teeth of the first intermediate gear 6c×the number of teeth of the first drive gear 14b/the number of teeth of the sixth drive gear 14f×the number of teeth of the second intermediate gear 6b) when the first intermediate gear 6c is connected with the second intermediate gear 6b.

The second intermediate gear 6b further engages with a first accessory-shaft gear 23a.

The first accessory-shaft gear 23a is capable of connecting with a second accessory-shaft gear 23b, which is rotatably supported on an accessary shaft 23, by using a sixth sleeve 23c, while the second accessory-shaft gear 23b engages with a fourth drive gear 16c. The second accessory-shaft gear 23b and the fourth drive gear 16c are illustrated to be apart from each other in FIG. 4, but they are actually engaged with each other as shown in FIG. 5.

Herein, iR3, which has a negative value, is set as a reduction ratio from the sixth drive gear 14f to the fourth drive gear 16c (the number of teeth of the first intermediate gear 6c×the number of teeth of the first accessory-shaft gear 23a×the number of teeth of the fourth drive gear 16c/the number of teeth of the sixth drive gear 14f×the number of teeth of the second intermediate gear 6b×the number of teeth of the second accessory-shaft gear 23b) when the first accessory-shaft gear 23a is connected with a second accessory-shaft gear 23b by using the sixth sleeve 23c.

As described above, as the sixth drive gear 14f is provided in the second embodiment, and the third drive gear 14d of the first embodiment is moved toward the second drive shaft 16 from the position thereof in the first embodiment, being formed integrally with a fifth drive gear 16c to function as a third drive gear 16d in the second embodiment that relates to “LOW” speeds and “HIGH”-speeds.

Herein, this third drive gear 16d will be described.

A second driven gear 22c engages with the fifth drive gear 16c that is arranged at a second drive-shaft side, and it is capable of connecting with a driven shaft 22 through a third driven gear 22d that engages with the third drive gear 16d that is formed integrally with the fifth drive gear 16c.

That is, the third drive gear 16d is arranged at a position different from that in the first embodiment, while it can provide LOW speeds. Accordingly, the third drive gear 16d and the fifth sleeve 22g function like that of an accessory drive device as well as the first embodiment.

As shown in FIG. 5, a center B of the first drive shaft 14 and a first clutch 10 is arranged at a lower side, and a center D of the second drive shaft 16 and a second clutch 12 is arranged at a higher side. Accordingly, the positions thereof in the first embodiment are replaced with those in the second embodiment.

A center G of the accessory shaft 23, which related to a backward driving operation, is somewhat different from that in the first embodiment.

A center C of a power intermediate gear 6 is arranged at the almost same position as that in the first embodiment.

The other parts are constructed similar to those of the first embodiment.

The operation of the device of the second embodiment will be described with reference to an operation table shown in FIG. 6.

As shown in FIG. 6, the drive device of the second embodiment provides nine forward speeds and one reverse speed.

In the operation table, arrows showing movement directions of the third sleeve 22e and the fourth sleeve 22f are illustrated by united arrows, because the both sleeves 22e and 22f are mechanically coupled to move together in a longitudinal direction.

The gear ratios are set as follows in the second embodiment, for example.

iL1: 2.305

i1: 0.733

i2: 0.441

i3: 1.220

iR3: −2.970

iS: 1.290

In order to establish the first speed, the third sleeve 22e and the fourth sleeve 22f are moved toward a right side in FIG. 4 to connect the first driven gear 22b with the second driven gear 22c. In addition, the fifth sleeve 22g is moved to the right side to connect the driven shaft 22 with the third driven gear 22d, and the seventh sleeve 6d is moved toward a left side to connect the first intermediate gear 6c with the second intermediate gear 6b. Then the first clutch 10 is engaged to drive a motor vehicle, the second clutch 12 being disengaged.

A speed ratio at the first speed is iL1·i1·i2, so that it becomes 4.674 under the above-set gear-ratio condition.

After the first speed, a second speed to a ninth speed in the second embodiment correspond to the first speed to eighth speed in the first embodiment, respectively. Accordingly, the operations of the sleeves and calculation of speed ratios are similar to those of the first embodiment, and their explanation is omitted.

The first to fifth speeds correspond to “LOW” speeds, and the sixth to ninth speeds correspond to “HIGH” speeds. Accordingly, the movements of the third sleeve 22e and the fourth sleeve 22f toward the left side are performed during the device being driven at the fourth speed or the fifth speed.

The respective speed ratios at the forward drive are shown as follows.

First speed. 4.674

Second speed: 2.615

Third speed: 2.028

Fourth speed: 1.574

Fifth speed: 1.220

Sixth speed: 0.946

Seventh speed: 0.733

Eighth speed: 0.569

Ninth speed: 0.441

A speed ratio at the reverse speed is −iR3/i3, so that it becomes −3.623 under the above-set gear-ratio condition.

In the second drive device, a gear step between the first speed and the second speed is 1.788, which is larger than the gear steps at the other forward speeds (approximately constant and 1.290). Ratio coverage (the speed ratio at the first speed/the speed ratio at the ninth speed) is 10.6. Therefore, suitable values of the speed ratios, the gear steps and the ratio coverage can be obtained when applied to transmissions of motor vehicles.

The drive device of the second embodiment has the following advantages in addition to those of the first embodiment.

In the drive device of the second embodiment, the forward first speed is newly added to the forward eight speeds of the drive device of the first embodiment, so that the second embodiment can provide a forward nine-speed drive device with approximately the same axial length as that of the first embodiment. Further, the device of the second embodiment can obtain the forward first speed with the gear step larger than others. This improves drivability of motor vehicles.

Next, a drive device of a third embodiment according to the present invention will be described with reference to FIGS. 7-10.

The third embodiment differs from the first embodiment in that the forward first to eighth speeds in the first embodiment are shifted to the second to ninth speeds of the third embodiment, respectively, and new first and tenth speeds are added to provide a forward ten-speed drive device.

In addition, it differs from the first embodiment in that the torque converter is removed, like the conventional dual clutch transmissions, and a first clutch 10 and a second clutch 12 are arranged near an engine 1, being connected with a crank shaft 2 of the engine 1.

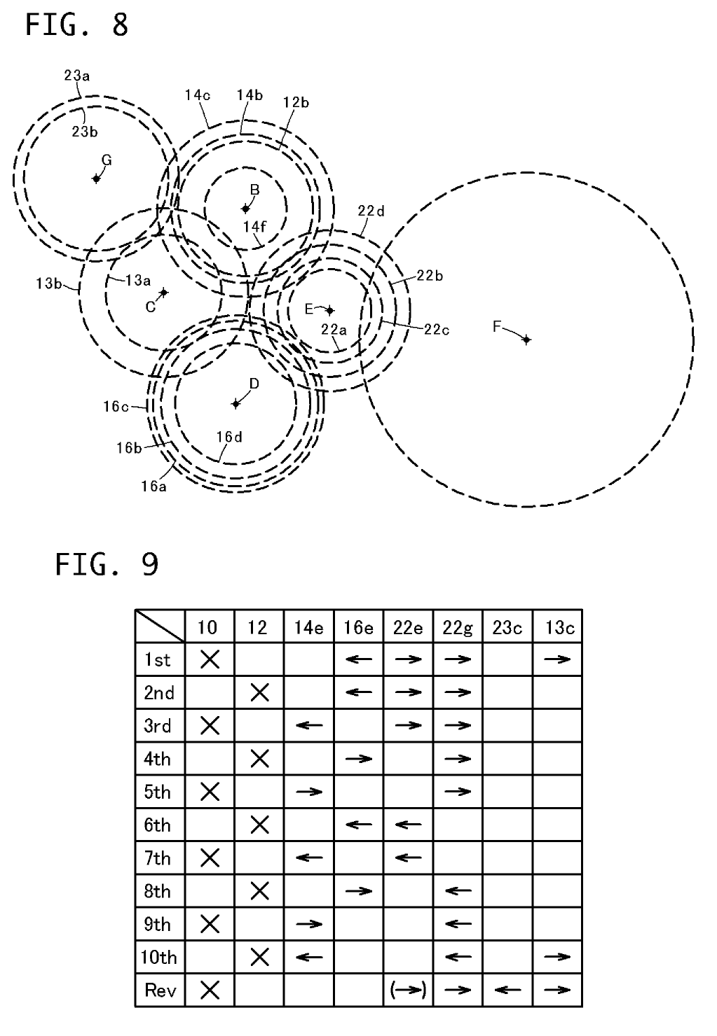

As shown in FIG. 8, shafts in the second embodiment are arranged at positions similar to those in the first embodiment.

A clutch plate 10a of the first clutch 10 is connected with a first drive shaft 14, and a clutch plate 12a of the second clutch 12 drives an input driven gear 16a formed integrally with a second drive shaft 16 through an input drive gear 12b and an input intermediate gear 13a that is formed integrally with an input intermediate shaft 13.

The input intermediate gear 13a and the input driven gear 16a are illustrated to be apart from each other in FIG. 7, but they are actually engaged with each other as shown in FIG. 8.

Herein, a gear ratio between the input drive gear 12b and the input driven gear 16a (the number of teeth of the input driven gear 16a/the number of teeth of the input drive gear 12b) is set iS2.

A sixth drive gear 14f, which is formed integrally with the first drive shaft 14, engages with a first intermediate gear 13b that is rotatably supported on the input intermediate shaft 13. The first intermediate gear 13b is capable of connecting with the input intermediate gear 13a when an eighth sleeve 13c is moved toward a right side in FIG. 7.

Herein, a speed ratio between the first drive shaft 14 and the input drive gear 12b (the speed of the first drive shaft 14/the speed of the input drive gear 12b) when they are connected with each other is set iL2.

A third drive gear 16d is formed integrally with a fifth drive gear 16c similarly to the second embodiment because of the existence of a sixth drive gear 14f.

Incidentally, the eighth sleeve 13c corresponds to a fifth selectively connecting mechanism.

On the other hand, as to a construction relating to a reverse speed, the first accessory-shaft gear 23a, which is formed integrally with the accessory-shaft 23, engages with intermediate gear 13a, the sixth sleeve 23c is capable of connecting with the first accessory-shaft gear 23a with the second accessory-shaft gear 23b that is rotatably supported on the accessory shaft 23, and the second accessory-shaft gear 23b engages with the second drive gear 14c. The second accessory-shaft gear 23b and the second drive gear 14c are illustrated to be apart from each other in FIG. 7, but they actually engage with each other as shown in FIG. 8.

Herein, a speed ratio between the first drive shaft 14 and the second drive gear 14c (the rotational speed of the first drive shaft 14/the rotational speed of the second drive gear 14c) is set iR4 when the first accessory-shaft gear 23a is connected with the second accessory-shaft gear 23b by using the sixth sleeve 23c.

The third sleeve 22e and the fourth sleeve 22f of the second embodiment, which are constructed to move together in the axial direction, are integrally formed with each other and replaced by a single sleeve, namely a third sleeve 22e in the third embodiment.

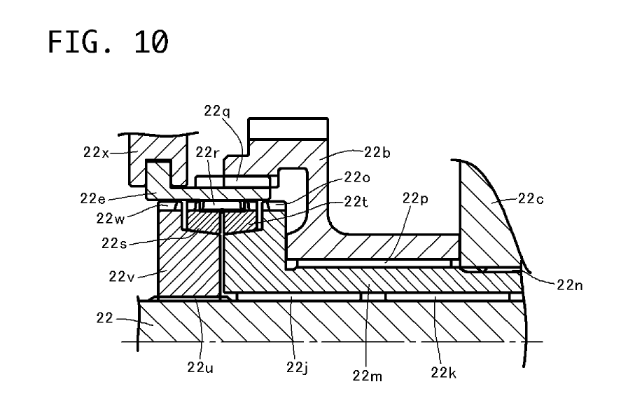

The third sleeve 22e and a periphery thereof are shown in FIG. 10, which illustrates an upper half thereof on a center axis of a driven shaft 22.

A connecting sleeve 22m is supported on an outer circumference of the driven shaft 22 through bearings 22j and 22k, and splines 22n formed on the connecting sleeve 22m are engaged with a second driven gear 22c. In addition, the connecting sleeve 22c is formed with dog teeth 22o on an outer circumference thereof.

A first driven gear 22b is supported on the connecting sleeve 22m through a bearing 22p, being formed with splines 22q with which third sleeve 22e engages. The third sleeve 22e is capable of moving in the axial direction. The third sleeve 22e is formed with splines 22r on an outer circumference thereof, the splines 22r is designed to engage with the dog teeth 2o of the connecting sleeve 22m to connect the first driven gear 22b with the second driven gear 22c through a synchronizer device 22t when the third sleeve 22e is moved toward the right side in FIG. 10. On the other hand, the splines 22r are designed to engage with dog teeth 22w formed on a connecting sleeve 22v, which has splines 22u engaged with the driven shaft 22 and is arranged at the left side of the connecting sleeve 22m, to connect the first driven gear 22b with the driven shaft 22 when the third sleeve 22e is moved toward the left side in FIG. 10.

The third sleeve 22e is moved in the axial direction by using a shift fork that is partially shown in FIG. 10.

Thus, the third sleeve 22e of the third embodiment performs a function of the both of the third sleeve 22e and the fourth sleeve 22f in the first and second embodiments.

The other parts are similar to those of the first and second embodiments.

The operation of the third embodiment will be described with reference to an operation table shown in FIG. 9. A part of the operation similar to those of the first and second embodiments, and the explanation thereof is omitted.

As shown in FIG. 9, the drive device of the third embodiment can establish forward ten speeds and reverse one speed.

In the following calculation on speed ratios, a rotational speed of a crank 2 is set 1 for convenience.

The gear ratios are set as follows in the third embodiment, for example.

iL2: 1.850

i1: 0.880

i2: 0.572

i3: 1.353

iR4: −3.957

iS: 1.240

In order to establish a first speed, the third sleeve 22e is moved toward the right side to connect the first driven gear 22b with the second driven gear 22c, a fifth sleeve 22g is moved toward the right side to connect the driven shaft 22 with a third driven gear 22d, the eighth sleeve 13c is moved toward the right side to connect the first intermediate gear 13b with the input intermediate gear 13, and then the first clutch 10 is engaged, the second clutch 12 being released.

A first speed ratio is iL2·iS·i1·i3/i2, so that it becomes 4.775 under the above-set gear-ratio condition.

After the first speed, the second speed to eighth speed of the first embodiment correspond to the second speed to ninth speed in the third embodiment, respectively. Accordingly, the operations of the sleeves and calculation of speed ratios are similar to those of the first embodiment, and the explanation thereof is omitted.

The first to fifth speeds correspond to “LOW” speeds, and the sixth to ninth speeds correspond to “HIGH” speeds. Accordingly, the movements of the third sleeve 22e and the fourth sleeve 22f toward the left side are performed during the device being driven at the fourth speed or the fifth speed.

A shift from the ninth speed to the tenth speed cannot be performed only by releasing the first clutch 10 and engaging the second clutch 12 in the third embodiment. Accordingly, the first and second clutches 10 and 12 are once released, and the first sleeve 14e is moved toward the left side and the eighth sleeve 13c is moved toward the right side, and then the second clutch 12 is engaged, the first clutch 10 being disengaged.

As a result, a speed ratio at the tenth speed is i1/iL2, so that it becomes 0.476 under the above-set condition.

The respective speed ratios at the forward drive are as follows.

First speed: 4.775

Second speed: 2.581

Third speed: 2.082

Fourth speed: 1.678

Fifth speed: 1.353

Sixth speed: 1.091

Seventh speed: 0.880

Eighth speed: 0.709

Ninth speed: 0.572

Tenth speed 0.476

A speed ratio at the reverse speed is −iR4·i3, so that it becomes −3.623 under the above-set gear-ratio condition.

In the third drive device, a gear step between the first speed and the second speed is 1.850, which is larger than the gear steps at the other forward speeds (approximately constant and 1.240). Ratio coverage (the speed ratio at the first speed/the speed ratio at the tenth speed) is 10.03. Therefore, suitable values of the speed ratios, the gear steps and the ratio coverage can be obtained when applied to transmissions of motor vehicles.

The drive device of the third embodiment has the following advantages in addition to those of the first and second embodiments.

In the drive device of the third embodiment, the forward first and tenth speeds are newly added to the forward eight speeds of the drive device of the first embodiment, so that the third embodiment can provide a forward ten-speed drive device with approximately the same axial length as that of the first embodiment.

Further, the device of the third embodiment can obtain the forward first speed with the gear step larger than others. This improves drivability of motor vehicles.

As explained above, the drive device of the present invention can provide a drive device with forward speeds up to from an eighth speed to a tenth speed even in a case where its axial length is limited when it is applied to a motor vehicle having a forward engine and driving front wheels, what is called, an FF vehicle. Notably, the ninth speed and the tenth speed can be set to have speed ratios preferable for applying to automobiles.

In addition, there is no other frictional clutch to be added to the first and second clutches 10 and 12 in order to obtain the eighth speed or more than eighth speed.

While there have been particularly shown and described with reference to preferred embodiments thereof, it will be understood that various modifications may be made therein, and it is intended to cover in the appended claims all such modifications as fall within the true spirit and scope of the invention.

For example, it can be applied to a hybrid electric vehicle. Specifically, an electric motor is added and connected with the first drive shaft 14 or a gear that rotates together with the first drive shaft 14 to drive them.

The entire contents of Japanese Patent Application No. 2014-177939 filed Sep. 2, 2014 are incorporated herein by reference.

What is claimed is:

1. A drive device for a motor vehicle comprising:
a first clutch that is capable of receiving power from a crank shaft of an engine;
a second clutch that is capable of receiving the power from the crank shaft;
a driven shaft;
a first drive gear;
a second drive gear;
a third drive gear;
a fourth drive gear;
a fifth drive gear;
a first driven gear;
a second driven gear;
a third driven gear;
a first selectively connecting mechanism;
a second selectively connecting mechanism;
a third selectively connecting mechanism;
a first drive shaft that is capable of receiving the power through the first clutch, the first drive shaft rotatably supporting the first drive gear and the second drive gear, and the first drive shaft being capable of connecting selectively with one of the first drive gear and the second drive gear through the first selectively connecting mechanism; and
a second drive shaft that is arranged parallel to the first drive shaft, the second drive shaft being capable of receiving the power that rotates at a speed lower than a speed of the first drive shaft, the second drive shaft rotatably supporting the fourth drive gear and the fifth drive gear, and the second drive shaft being capable of connecting selectively with one of the fourth drive gear and the fifth drive gear through the second selectively connecting mechanism, wherein
the third drive gear is formed integral with one of the second drive gear and the fifth drive gear, wherein
the first driven gear is arranged parallel to the first drive shaft and the second drive shaft, the first driven gear being engaged with the first drive gear and the fourth drive gear, wherein
the second driven gear is engaged with the second drive gear and the fifth drive gear, wherein
the third driven gear is engaged with the first drive gear, wherein
the driven shaft rotatably supports the first driven gear, the second driven gear and the third driven gear, the driven shaft being connectable selectively with the first driven gear, the second driven gear and the third driven gear through the third selectively connecting means, and wherein
the first driven gear is capable of being selectively connected with the second driven gear.

2. The drive device according to claim 1, further comprising:
a power intermediate gear;
the second clutch is capable of being driven by the crank shaft through the power intermediate gear.

3. The drive device according to claim 2, further comprising:
a plurality of gears that are arranged between the first drive shaft and the first drive gear; and
a fourth selectively connecting mechanism that is capable of connecting the first drive shaft with the first drive gear, wherein
the first drive shaft drives the first drive gear at a reduction speed through the plurality of gears and the fourth selectively connecting mechanism to provide a first speed.

4. The drive device according to claim 2, further comprising:
a single sleeve that is capable of connecting the first driven gear with the driven shaft and further connecting the first driven gear with the second driven gear.

5. The drive device according to claim 3, further comprising:
a single sleeve that is capable of connecting the first driven gear with the driven shaft and further connecting the first driven gear with the second driven gear.

6. The drive device according to claim 1, further comprising:
an input intermediate gear, wherein
the crank shaft is connected with the second clutch, and wherein
the second clutch drives the second drive shaft at a reduction speed through the input intermediate gear.

7. The drive device according to claim 6, further comprising:
a plurality of gears that are arranged between the first drive shaft and the input intermediate gear; and
a fifth selectively connecting mechanism that is capable of connecting the first drive shaft with the input intermediate gear; wherein
the first drive shaft drives the input intermediate gear at a reduction speed through the plurality of gears and the fifth selectively connecting mechanism.

8. The drive device according to claim 1, further comprising:
a single sleeve that is capable of connecting the first driven gear with the driven shaft and further connecting the first driven gear with the second driven gear.

9. The drive device according to claim 5, further comprising:
a single sleeve that is capable of connecting the first driven gear with the driven shaft and further connecting the first driven gear with the second driven gear.

10. The drive device according to claim 7, further comprising:
a single sleeve that is capable of connecting the first driven gear with the driven shaft and further connecting the first driven gear with the second driven gear.
